(19) United States
(12) Patent Application Publication
(10) Pub. No.: US 2009/0097243 A1
(43) Pub. Date: Apr. 16, 2009

(54) LED LAMP WITH A POWERLESS FAN

(75) Inventors: HAI LAN, Tu-Cheng (TW); SHUN-YUAN JAN, Tu-Cheng (TW); CHUNG-YUAN HUANG, Santa Clara, CA (US)

Correspondence Address: PCE INDUSTRY, INC.;ATT. Steven Reiss, 458 E. LAMBERT ROAD, FULLERTON, CA, 92835, US

(73) Assignee: FOXCONN TECHNOLOGY CO., LTD., Tu-Cheng (TW)

(21) Appl. No.: 12/248,027

(22) Filed: Oct. 8, 2008

(30) Foreign Application Priority Data
Oct. 10, 2007 (CN) 200710123806.X

(51) Int. Cl. F21V 33/00

(52) U.S. Cl. 362/234

(57) ABSTRACT

An LED lamp (100) includes a heat sink (10), a powerless fan (30) and a plurality of LEDs (50). The fan is secured to the heat sink. The fan has an impeller (33) located above the heat sink. The LEDs are attached to a bottom of the heat sink. Heat generated by the LEDs is transferred to the heat sink, and accordingly, a natural convection is formed by a temperature gradient of air in the heat sink and pushes the impeller to rotate to generate a forced airflow toward the heat sink, which, in turn, enhances the natural convection of the air in the heat sink.

### BACKGROUND

1. Field of the Invention

The present invention relates to a light emitting diode (LED) lamp, and more particularly to an LED lamp incorporating a powerless fan for increasing a heat dissipation thereof.

2. Description of Related Art

With the continuing development of scientific technology and the raise of people's consciousness of energy saving, LEDs have been widely used in the field of illumination due to their small size and high efficiency. It is well known that an LED lamp with LEDs arranged side-by-side in large density generates a lot of heat when it emits light. If the heat cannot be quickly removed, the LED lamp may become overheated, significantly reducing work efficiency and service life thereof.

Conventionally, a heat sink is used to attach to an outer side of the LED lamp for dissipating heat generated by the LEDs. The heat sink includes a base and a plurality of fins extending from the base. The heat of the LEDs is transferred to the base at first, and then is dissipated to ambient air in a natural convection manner by the fins of the heat sink. However, it is difficult to dissipate a large amount of heat accumulating in a bottom portion between the base and the fins, because airflow can not substantially flow through the bottom portion in the natural convection manner.

What is needed, therefore, is an LED lamp which has an improved heat dissipation efficiency.

### SUMMARY

An LED lamp according to an exemplary embodiment includes a heat sink, a powerless fan and a plurality of LEDs. The fan is secured to the heat sink. The fan has an impeller located above the heat sink. The LEDs are attached to a bottom of the heat sink. Heat generated by the LEDs is transferred to the heat sink, and accordingly, a natural convection is formed by a temperature gradient of ambient air in the heat sink and pushes the impeller to rotate to generate a forced airflow toward the heat sink. The forced airflow can accelerate the natural convection, whereby heat accumulated at bottoms of fins of the heat sink can be more easily dissipated.

Other advantages and novel features of the present invention will become more apparent from the following detailed description when taken in conjunction with the accompanying drawings.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an isometric, assembled view of an LED lamp in accordance with a first embodiment.

FIG. 2 is an isometric, explored view of the LED lamp shown in FIG. 1.

FIG. 3 shows a flowing path of heated air of the LED lamp shown in FIG. 1, wherein blades of a fan of the LED lamp do not rotate.

FIG. 4 shows a flowing path of heated air of the LED lamp shown in FIG. 1, wherein blades of a fan of the LED lamp rotate.

FIG. 5 is an isometric, assembled view of an LED lamp in accordance with a second embodiment.

### DETAILED DESCRIPTION

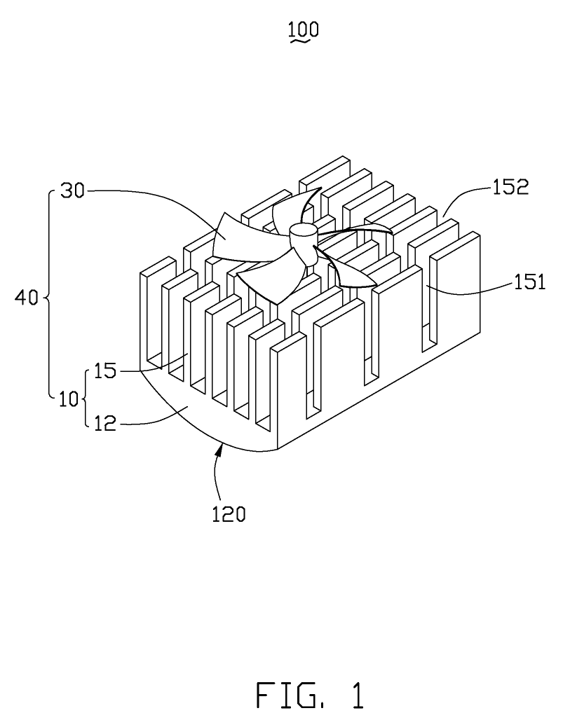

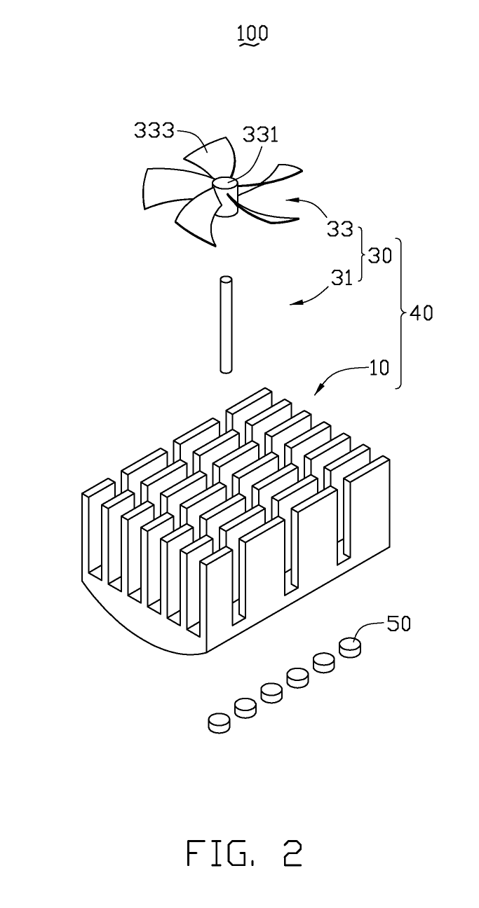

Referring to FIGS. 1-2, an LED lamp 100 in accordance with a first embodiment of the present invention for a lighting purpose is shown. The LED lamp 100 includes a heat dissipation device 40 and a plurality of LEDs 50. The heat dissipation device 40 includes a heat sink 10 and a powerless fan 30. The LEDs 50 are used for emitting light and attached to a bottom of the heat sink 10. The fan 30 is mounted above a top of the heat sink 10.

The heat sink 10 includes a base 12 and a plurality of fins 15. The base 12 has an arched bottom surface 120. The fins 15 extend integrally and upwardly from a top surface of the base 12. A plurality of gaps 151, 152 are respectively defined along transverse and longitudinal directions of the fins 15. The LEDs 50 are evenly spaced from each other and attached to the bottom surface 120. The heat sink 10 is made of metal such as aluminum, copper or alloy thereof, which has a good thermal conductivity.

The fan 30 includes a supporting pole 31 and an impeller 33 rotatablely mounted on the supporting pole 31. The impeller 33 includes a hub 331 and a plurality of blades 333 extending outwardly from a periphery of the hub 331. The hub 331 is rotatablely mounted on the supporting pole 31 via a bearing (not shown) so that the impeller 33 can rotate around the supporting pole 31 freely. The fan 30 is an axial fan for generating an axially forced airflow. The supporting pole 31 is made of a material having a low thermal conductivity, such as plastic.

A bottom of the supporting pole 31 is fixed to the base 12 of the heat sink 10. Alternatively, the supporting pole 31 can be fixed between the fins 15. The impeller 33 is made of a light material, such as plastic or aluminum. Alternatively, the impeller 33 can be made of stainless steel for having a good strength.

A bottom side of each blade 333 is painted to have a fuscous color, such as black. In assembly, the fan 30 is vertically positioned as that the impeller 33 can be located above the fins 15 with the bottom sides of the blades 333 facing the fins 15.

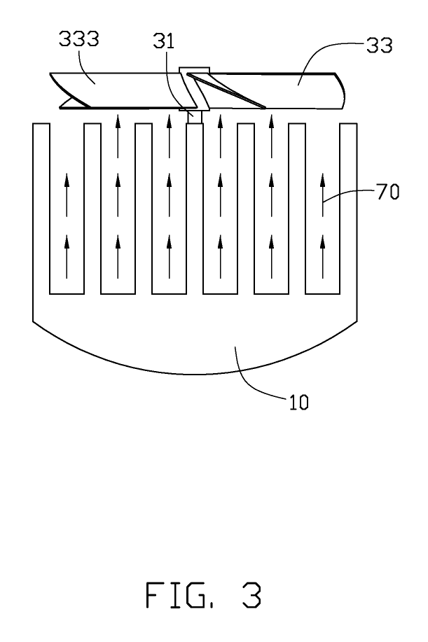

Referring to FIG. 3, the LEDs 50 are powered to work and generate heat gradually. The heat is transferred to the base 12 of the heat sink 10. Accordingly, air in a bottom portion of the fins 15 of the heat sink 10 is heated and gradually accumulated in the gaps 151, 152. Because the supporting pole 31 is adiabatic, the heat will not be conducted to the fan 30. The heated air in the gaps 151, 152 flows upwardly so that a natural convection is generated in the air among the fins 15 of the heat sink 10, as shown by arrows 70.

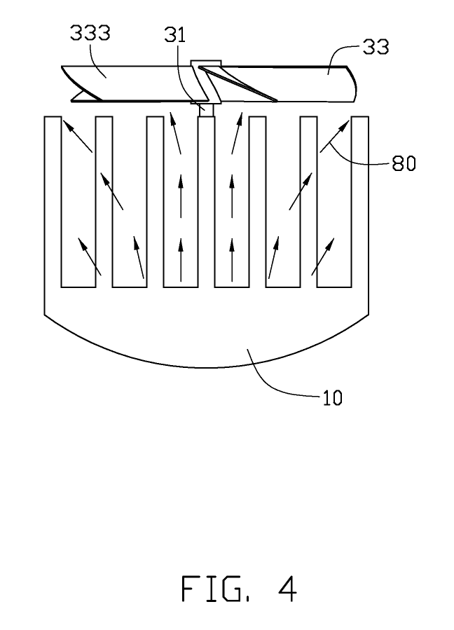

Referring to FIG. 4, when the natural convection becomes strong enough to drive the blades 333 of the fan 30 to rotate, the blades 333 rotate consequently to generate the axially forced airflow to push the heated air among the fins 15 flowing out the heat sink 10 sideways, as shown by arrows 80, so that the natural convention in the air among the fins 15 is enhanced and heat accumulated in the bottoms of the gaps 151, 152 can be more easily removed. Thus, the heat can be drawn out from the heat sink 10 and the LEDs 50 more quickly. Thus, the fan 30 can improve the heat dissipation efficiency of the LED lamp 100, without consuming any power.

The blades 333 of the fan 30 having the black bottom sides can efficiently absorb heat energy of the heat sink 10 so as to dissipate the heat of the heated air in the heat sink 10, and thus strengthen the natural convection of the air among the fins 15 of the heat sink 10. Furthermore, the fan 30 does not need consuming electric power. The fan 30 has a longer service life than the conventional fan which needs consuming electric power and is suitable to be used in an outdoor environment.

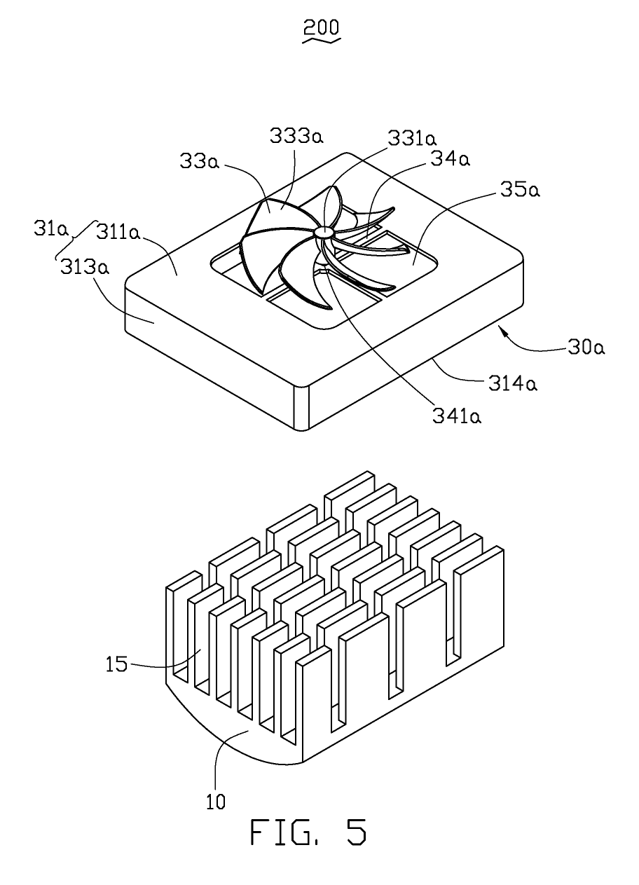

Referring to FIG. 5, an LED lamp 200 in accordance with a second embodiment for a lighting purpose is shown. The LED lamp 200 is similar to the LED lamp 100, only differing in the structure of the fan 30a. The fan 30a of the LED lamp 200 includes a mounting cover 31a and an impeller 33a. The mounting cover 31a is made of a material having a low thermal conductivity, such as plastic. The mounting cover 31a includes a rectangular top wall 311a and four lateral walls 313a. The lateral walls 313a extend downwardly from four sides of the top wall 311a respectively. The lateral walls 313a and the top wall 311a are cooperated to form a recess 314a. The recess 314a has a similar shape and size to a top of the heat sink 10 so that the mounting cover 31a can be fittingly secured to the top of the heat sink 10.

A rectangular opening 35a is defined in a middle of the mounting cover 31a. A cross bracket 34a is located in the opening 35a and connects with the mounting cover 31a via ends thereof. The bracket 34a has a supporting pole 341a. The supporting pole 341a of the fan 30a is fixed to a center of the bracket 34a, and the impeller 33a is rotatablely supported by the supporting pole 341a. Similarly, the impeller 33a has a hub 331a and a plurality of blades 333a. The impeller 33a is located above the top wall 311a with bottom sides of the blades 333a facing the opening 35a. Heated air in the heat sink 10 can reach the blades 333a through the opening 35a to drive the impeller 33a to rotate.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An LED lamp comprising:
a plurality of LEDs for emitting light, heat being generated when the LEDs generate light;
a heat sink thermally attaching to the LEDs for absorbing heat from the LEDs; and
a powerless fan having a supporting pole secured to the heat sink and an impeller rotatabley supported by the supporting pole, the impeller located above the heat sink, when the LEDs emit light and generate heat, a natural convection being formed by air in the heat sink, the natural convention pushing the impeller to rotate to generate a forced airflow toward the heat sink, which, in turn, enhances the natural convection of the air in the heat sink.

2. The LED lamp as claimed in claim 1, wherein the impeller comprises a hub and a plurality of blades extending outwardly from a periphery of the hub, the hub being rotatablely mounted on the supporting pole so that the impeller can rotate around the supporting pole freely.

3. The LED lamp as claimed in claim 1, wherein the supporting pole is made of an adiabatic material.

4. The LED lamp as claimed in claim 1, further comprising a mounting cover assembled to the heat sink, an opening being defined in the mounting cover, the supporting pole being fixed to the cover and the impeller located at a position corresponding to the opening.

5. The LED lamp as claimed in claim 4, wherein the mounting cover includes a top wall and a plurality of lateral walls extending downwardly from sides of the top wall respectively, the lateral walls and the top wall are cooperated to form a recess so as to mount the mounting cover to a top of the heat sink.

6. The LED lamp as claimed in claim 4, wherein a bracket is located in the opening and connects with the mounting cover, the impeller has a hub and a plurality of blades, the supporting pole is fixed to the bracket and the hub is rotatablely mounted on the supporting pole and above the opening.

7. The LED lamp as claimed in claim 4, wherein the mounting cover is made of an adiabatic material.

8. The LED lamp as claimed in claim 1, wherein the fan is an axial fan.

9. The LED lamp as claimed in claim 1, wherein the impeller is made of a material selected from a group consisting of plastic, aluminum and stainless steel.

10. The LED lamp as claimed in claim 1, wherein the heat sink includes a base and a plurality of fins, the fins extend upwardly from a top of the base, and a plurality of gaps are respectively defined along transverse and longitudinal directions of the fins.

11. The LED lamp as claimed in claim 1, wherein a bottom side of the impeller facing the heat sink has a black color.

12. An LED lamp comprising
an LED module having a plurality of LEDs for emitting light, heat being generated when the LEDs generate light;
a powerless fan having a mounting device secured to the LED module and an impeller rotatabley supported by the mounting device, the impeller located above the LED module, a natural convection being formed by air in the LED module when the LEDs lighten and generate heat, and the natural convention pushing the impeller to rotate to generate a forced airflow toward the LED module, which, in turn, enhances the natural convection in the LED module.
